(19) United States
(12) Patent Application Publication
(10) Pub. No.: US 2008/0017684 A1
(43) Pub. Date: Jan. 24, 2008

(54) Counter top paper towel dispenser

(76) Inventor: Michelle Digiacomo, Placerville, CA (US)

Correspondence Address: JAMES RAY & ASSOCIATES, 2640 PITCAIRN ROAD, MONROEVILLE, PA, 15146, US

(21) Appl. No.: 11/880,805

(22) Filed: Jul. 24, 2007

Related U.S. Application Data
(60) Provisional application No. 60/832,869, filed on Jul. 24, 2006.

(51) Int. Cl. B26F 3/02

(52) U.S. Cl. 225/14

(57) ABSTRACT

An apparatus for dispensing paper towels in a public restroom. The apparatus comprises a container member disposed one of inside and beneath a sink counter top for holding paper towels, such container member having a first predetermined shape, a first predetermined size and formed of a first predetermined material. A lid member is removably engageable with the container member, such lid member has a second predetermined shape, a second predetermined size and is formed of a second predetermined material. A release port is disposed in the lid member for dispensing such paper towels one at a time.

### CROSS REFERENCE TO RELATED APPLICATIONS

This application is closely related to and claims benefit from U.S. Provisional Application Ser. No. 60/832,869 filed Jul. 24, 2006.

### FIELD OF THE INVENTION

The present invention relates, in general, to a counter top dispenser, and, more particularly, the present invention relates to a counter top towel dispenser for use in a public restroom in which the dispenser and, thus, the towels are within easy reach of a person at a sink enabling such user to dry the hands immediately without leaving the sink area.

### BACKGROUND OF THE INVENTION

Using a public restroom can be a daunting experience as the sink area can be messy and difficult to access, leaving a user annoyed or even unable to wash the hands. Many times the hand dryer or towel dispenser is located several or more feet away on another wall causing the user with wet hand to drip across the sink top and over the floor before he/she can reach the towels to dry the hands. Often times a person with physical disabilities cannot manage to access or is unable to reach the dryer or towel dispenser.

Thus, it would be advantageous if there were an apparatus or a means for enabling the restroom user a simple and sanitary way to access a paper towel for drying the hands while still at the sink.

### SUMMARY OF THE INVENTION

In a first aspect the present invention provides an apparatus for dispensing paper towels in a public restroom. The apparatus comprises a container member disposed one of inside and beneath a sink counter top for holding paper towels, such container member having a first predetermined shape, a first predetermined size and formed of a first predetermined material. A lid member is removably engageable with the container member, such lid member has a second predetermined shape, a second predetermined size and is formed of a second predetermined material. A release port is disposed in the lid member for dispensing such paper towels one at a time.

In another aspect the present invention provides An apparatus disposed in a sink counter top for dispensing paper towels. The apparatus comprises a container member disposed one of inside and beneath such sink counter top for holding paper towels. The container member has a first predetermined shape, a first predetermined size and is formed of a first predetermined material. A lid member is removably engageable with the container member, such lid member has a second predetermined shape, a second predetermined size and is formed of a second predetermined material. A release port is disposed in the lid member for dispensing such paper towels one at a time.

### OBJECTS OF THE INVENTION

It is, therefore, one of the primary objects of the present invention to provide a paper towel dispenser that is disposed on or in the counter top close to the sink area.

Another object of the present invention to provide a paper towel dispenser that is built in to the counter top close to the sink area.

Still another object of the present invention to provide a paper towel dispenser that dispenses the towels one at a time.

Yet another object of the present invention to provide a counter top paper towel dispenser where the lid is removably engaged to the container.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE DRAWINGS

FIG. 1 is a perspective view of the counter top apparatus for dispensing paper towels.

FIG. 2 is an elevational side view of the counter top apparatus seen in FIG. 1.

FIG. 3 is a perspective view of a person using the counter top apparatus.

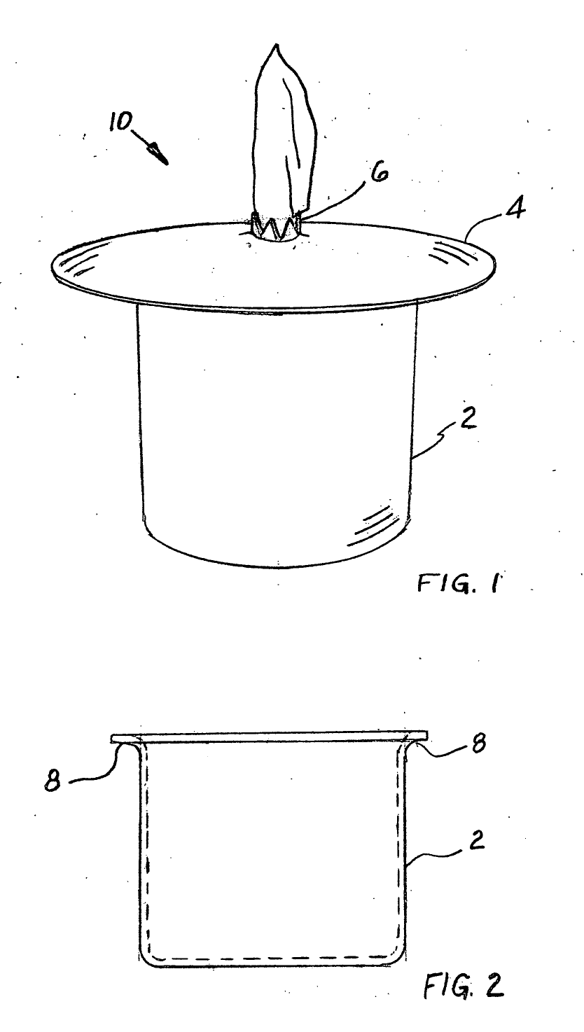

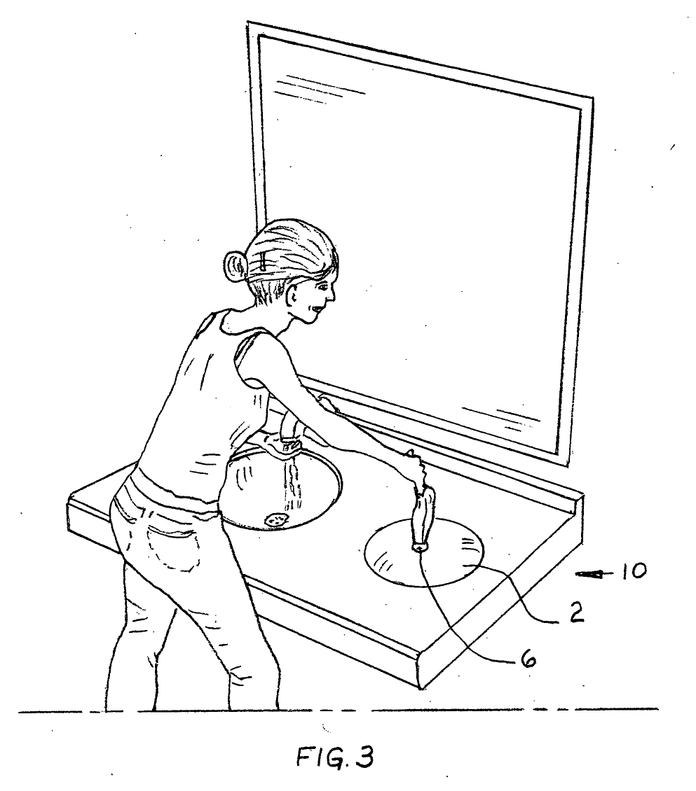

### BRIEF DESCRIPTION OF THE PRESENTLY PREFERRED AND VARIOUS ALTERNATIVE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10,for dispensing paper towels in a public restroom. The apparatus 10 comprises a container member 2 that is disposed one of inside and beneath a sink counter top for holding paper towels, such container member 2 having a first predetermined shape, a first predetermined size and formed of a first predetermined material. A lid member 4 is removably engageable with the container member 2, such lid member 4 has a second predetermined shape, a second predetermined size and is formed of a second predetermined material. A release port 6 is disposed in the lid member 4 for dispensing such paper towels one at a time.

The first predetermined shape of the container member 2 is one of cylindrical, rectangular, oval, and hexagonal. It is presently preferred that such shape of the container member 2 is substantially cylindrical. The second predetermined shape of the lid member 4 can also be any shape to fit the contour of the design, thus, it could be round (preferable), square, hexagonal, oval or any desired shape.

It is also presently preferred that such first predetermined shape of the container member 2 further includes a lip portion 8 that engages such sink counter top so as to maintain the position of the container member 2 into the counter top. The lip portion 8 also prevents the container member from falling through the sink where the sink is shallow and has only a counter top and there is no part of the sink below the container member 2.

As stated previously the lid member 4 is removably engageable with the container member 4. It is removably engageable by means of being a snap on and screw on. It is presently preferred that such lid member 4 is removably engageable with the container member 2 by a snap on arrangement. The lid member 4 is removed for the addition of replacement paper towels. When new towels are added the first towel is pulled up through the release port 8 in the lid member 4 and then the lid member 4 is snapped on to the container member 2. Further the release port 8 is disposed substantially in a center of the lid member 4.

There is also a rubber seal on the underside of the lid member 2 where it would seal against the lip portion 6 of the container member 4 so as to prevent any water from leaking into the container member 3.

In another aspect the present invention provides an apparatus 10 disposed in a sink:counter top for dispensing paper towels. Such sink counter top can be anywhere. The apparatus 10 comprises a container member 2 disposed one of inside or beneath such sink counter top for holding paper towels. The container member 2 has a first predetermined shape, a first predetermined size and is formed of a first predetermined material. A lid member 4 is removably engageable with the container member 2, such lid member 4 has a second predetermined shape, a second predetermined size and is formed of a second predetermined material. A release port 6 is disposed in the lid member 4 for dispensing such paper towels one at a time.

Such first predetermined material can be one of metal, plastic or combinations thereof. It is presently preferred that such first predetermined material is plastic. Being made of plastic there is no problem with rusting of any of the parts. The second predetermined material can also be metal or plastic. It is preferred that such second material be the same as the first predetermined material.

Thus, the present invention provides a counter top dispenser that is designed for use in commercial or public restroom sink fixtures. The dispenser provides easy access to paper towels with which to dry the hands after washing. Presently in most publis restrooms the towel dispenser or the drying apparatus is disposed on a wall that is generally far removed from the sink. This means that the user has to walk across the floor with wet and possibly dripping hands thereby dripping water on the floor which can be a safety problem since wet floors can be slippery. The dispenser in the present invention is made to hold and offer one towel at a time through a specially designed lid. The dispenser is a built-in or add-on towel dispensing unit.

The preferably round counter top container is mounted inside or beneath the sink counter top in a predetermined manner within reach of the sink itself. The lid with a release port that allows the user to pull a single towel out of the dispenser is placed atop the container. The lid member is flush with the counter top. The towels placed inside the container are fed through the hole in the lid and are torn off one at a time. As stated previously the lid is removable so as to permit the addition of replacement towels which are placed inside. Upon replacement of the lid, the first towel is fed through the jagged release port to begin the release.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. An apparatus for dispensing paper towels in a public restroom, said apparatus comprising:
(a) a container member disposed one of inside and beneath a sink counter top for holding paper towels, said container member having a first predetermined shape, a first predetermined size and formed of a first predetermined material;
(b) a lid member removably engageable with said container member, said lid member having a second predetermined shape, a second predetermined size and formed of a second predetermined material; and
(c) a release port disposed in said lid member for dispensing such paper towels one at a time.

2. The apparatus, according to claim 1, wherein said predetermined shape of said container member is one of cylindrical, rectangular, oval, and hexagonal.

3. The apparatus, according to claim 2, wherein said predetermined shape of said container member is substantially cylindrical.

4. The apparatus, according to claim 1, wherein said first predetermined shape of said container member includes a lip portion that engages such counter top so as to maintain a position of said container member into said counter top.

5. The apparatus, according to claim 1, wherein said lid member is removably engageable with said container member by one of snap on and screw on.

6. The apparatus, according to claim 6, wherein said lid member is removably engageable with said container member by snap on.

7. The apparatus, according to claim 1, wherein said release port is disposed substantially in a center of said lid member.

8. The apparatus, according to claim 1, wherein said first predetermined material is selected from a group consisting of metal and plastic.

9. The apparatus, according to claim 1, wherein said first predetermined material is plastic.

10. An apparatus disposed in a sink counter top for dispensing paper towels, said apparatus comprising:
(a) a container member disposed one of inside and beneath such sink counter top for holding paper towels, said container member having a first predetermined shape, a first predetermined size and formed of a first predetermined material;
(b) a lid member removably engageable with said container member, said lid member having a second predetermined shape, a second predetermined size and formed of a second predetermined material; and
(c) a release port disposed in said lid member for dispensing such paper towels one at a time.

11. The apparatus, according to claim 10, wherein said predetermined shape of said container member is one of cylindrical, rectangular, oval, and hexagonal.

12. The apparatus, according to claim 11, wherein said predetermined shape of said container member is substantially cylindrical.

13. The apparatus, according to claim 10, wherein said first predetermined shape of said container member includes a lip portion that engages such counter top so as to maintain a position of said container member into said counter top.

14. The apparatus, according to claim 10, wherein said lid member is removably engageable with said container member by one of snap on and screw on.

15. The apparatus, according to claim 14, wherein said lid member is removably engageable with said container member by snap on.

16. The apparatus, according to claim 10, wherein said release port is disposed substantially in a center of said lid member.

17. The apparatus, according to claim 10, wherein said first predetermined material is selected from a group consisting of metal and plastic.

18. The apparatus, according to claim 17, wherein said first predetermined material is plastic.
